(19) United States
(12) Patent Application Publication
(10) Pub. No.: US 2013/0115356 A1
(43) Pub. Date: May 9, 2013

(54) SWEETENER COMPOSITION

(71) Applicants: Jean-Luc Gelin, Geneva (CH); Ronald H. Skiff, Plainsboro, NJ (US)

(72) Inventors: Jean-Luc Gelin, Geneva (CH); Ronald H. Skiff, Plainsboro, NJ (US)

(73) Assignee: FIRMENICH SA, Geneva 8 (CH)

(21) Appl. No.: 13/698,524

(22) PCT Filed: Jun. 22, 2011
(86) PCT No.: PCT/IB11/52739

§ 371 Date: Nov. 16, 2012

(30) Foreign Application Priority Data
Jun. 23, 2010 (EP) 10167025.5

(51) Int. Cl. A23L 1/236

(52) U.S. Cl. CPC A23L 1/2366
USPC 426/536

(57) ABSTRACT

A sweetening composition of stevia compound and a compound according to formula (I)

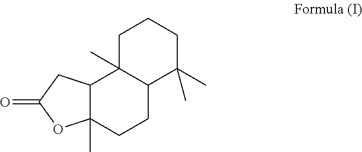 [SMILES: CC1(C)CCCC2(C)C1CCC1(C)OC(=O)CC12]

wherein the compound according to formula (I) is present in an amount of at least 0.0001%, by weight based on the total weight of the sweetening composition. The compound attenuates the liquorice taste associated with stevia or derivatives thereof.

### TECHNICAL FIELD

The present invention relates to a sweetener composition comprising a natural sweetener and sclareolide. The invention further relates to the use of sclareolide to reduce certain undesirable notes that can be associated with the natural sweetener.

### BACKGROUND AND PRIOR ART

Sugar is a popular sweetening additive in human food preparation. By sugar is to understood sucrose but also other commonly used calorie rich sweetening additives such as glucose, fructose and high fructose corn syrups. Popular feeding habits tend to show an over consumption of sugar even though it is well established that this is a known cause of various adverse effects on health, the most common including tooth decay and obesity.

To date, various products have been proposed which seek to address these problems. For instance, artificial high intensity sweeteners have been developed which deliver a sweet taste at very low doses. Of the high intensity sweeteners already present on the market, Sucralose®, Aspartame, Potassium Acesulfame, cyclamate, saccharine can be named as well known alternatives. However, there is a strong desire by an ever-increasing number of consumers for natural or naturally derived products in preference to their artificial counterparts. Thus, it would be highly desirable to provide a product which meets this consumer need.

Within the class of naturally occurring sweeteners, a growing number of products is becoming available. Examples include thaumatin, luo han guo, brazzein, curculin, glycyrrhizin and stevia. Of these sweeteners, stevia is possibly the most important, due to its wide availability and desirable sweetness profile.

However stevia suffers from the unique drawback that it leaves a liquorice aftertaste when consumed which, depending upon the application can be highly undesirable for consumers.

To the best of our knowledge, no single compound has been used previously to reduce or mask the liquorice aftertaste due to stevia.

Accordingly, the present invention seeks to address this issue.

### SUMMARY OF THE INVENTION

Thus, according to the present invention, there is provided a sweetening composition comprising:
(a) stevia and/or derivatives thereof, and
(b) a compound according to formula (I)

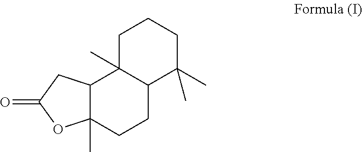 [SMILES: CC1(C)CCCC2(C)C1CCC1(C)OC(=O)CC12]

wherein the compound according to formula (I) is present in an amount of at least to 0.0001%, by weight based on the total weight of the sweetening composition.

The invention also provides a method of reducing or masking the liquorice note of stevia by applying a compound according to formula (I) in a composition comprising stevia.

### DETAILED DESCRIPTION OF THE INVENTION

The sweetener comprises stevia as an essential ingredient.

In the context of the present invention, the term “Stevia” denotes a material that consists of, includes or is derived from the stevia plant. Thus, Stevia can be taken to mean the Stevia plant itself, any sweet part thereof, extracts thereof, stevia derivatives, such as steviol glycosides and mixtures thereof.

Stevia or Stevia rebaudiana Bertoni is a sweet-tasting plant. The leaves contain a complex mixture of natural sweet diterpene glycosides. Steviol glycosides, e.g., steviosides and rebaudiosides, are components of Stevia that contribute sweetness. Typically, these compounds are found to include stevioside (4-13% dry weight), steviolbioside (trace), the rebaudiosides, including rebaudioside A (2-4%), rebaudioside B (trace), rebaudioside C (1-2%), rebaudioside D (trace), and rebaudioside E (trace), and dulcoside A (0.4-0.7%). The following non-sweet constituents also have been identified in the leaves of stevia plants: labdane, diterpene, triterpenes, sterols, flavonoids, volatile oil constituents, pigments, gums and inorganic matter.

Suitable stevia derivatives include stevia-based sweetening systems containing a high level of rebaudioside A, a main component contributing to the sweetness of stevia. Thus, it is preferred that the stevia component is a stevia derivative comprising more than 30%, more preferably more than 60%, even more preferably more than 85%, most preferably more than 90%, e.g. more than 95% rebaudioside A by weight based on the total weight of stevia component.

Other suitable stevia derivatives include stevia-based systems comprising a high to level of stevioside.

Alternatively, a suitable stevia derivative may comprise both stevioside and rebaudioside A at various ratios.

The sweetening composition further comprises a compound according to formula (I):

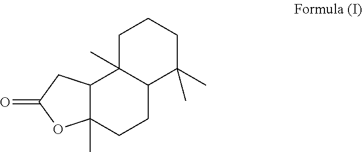 [SMILES: CC1(C)CCCC2(C)C1CCC1(C)OC(=O)CC12]

This compound, also known as sclareolide, is a diterpene extract from clary sage. It is widely commercially available from many suppliers, such as Avoca or and Chromadex, both USA.

In a foodstuff or beverage, components (a) and (b) may be present in amounts within the ranges of from 5 to 300 ppm and from 0.025 to 9 ppm respectively.

Thus, preferably component (a) is present at a concentration of from 5 to 300 ppm, more preferably 25 to 200 ppm, most preferably from 50 to 100 ppm. Component (b) is present at a concentration of from 0.025 to 9 ppm, preferably from 0.5 to 9 ppm, most preferably from 0.7 to 5 ppm. Thus, in a foodstuff or base comprising the sweetening composition according as defined herein, component (b) is present in an amount of from 0.025 to 10 ppm. This is because at levels outside this range the desired masking of liquorice off-notes is not achieved.

The composition can be provided in any suitable form, such as liquids, preferably transparent liquids or solids, such as powders, granules, tablets and the like.

The sweetening composition of the present invention, especially when concentrated or dried, can be used to provide natural sweetness for many purposes. Examples of such uses to provide sweetness are in beverages, such as tea, coffee, fruit juice and fruit-flavoured beverages; foods, such as jams and jellies, peanut butter, pies, puddings, cereals, candies, ice creams, yogurts, bakery products; health care products, to such as toothpastes, mouthwashes, cough drops, cough syrups; chewing gums; and sugar substitutes.

The invention will now be illustrated with reference to the following examples. All amounts are % by weight unless otherwise indicated.

### EXAMPLES

### Example 1

### Preparation of Lemon Ice Tea Beverage

Lemon ice tea beverages were prepared with the following ingredients in the amounts shown (grams). Base A is the full sucrose product (i.e. control sample). Base B is the same as base A except with 50% reduced sucrose and additional stevia sweetener in to provide the same level of sweetness.

TABLE 1

| Ingredient | Base A | Base B |
|---|---|---|
| Crystalline sucrose | 69.70 | 34.86 |
| Anhydrous citric acid | 1.90 | 1.90 |
| Powdered black tea extract (1) | 1.00 | 1.00 |
| Tricalcium phosphate | 0.50 | 0.50 |
| Solessence ® P flavour (2) | 0.08 | 0.08 |
| Stevia (3) | — | 0.13 |
| Water (4) | 954.19 | 975.90 |

(1) ex. Firmenich, Switzerland (ref: 365442 07TD0594)
(2) ex. Firmenich, Switzerland (ref: 540311 TP0345)
(3) Stevia derivative with 97% Rebaudioside A content, ex Blue California, USA
(4) Arkina, Switzerland

The ingredients for each base were mixed together until fully dissolved.

### Example 2

### Evaluation of beverages for Taste Differences to The following beverage samples were prepared and evaluated for flavor and taste attributes:

TABLE 2

| Component | Sample 1 (wt %) | Sample 2 (wt %) | Sample 3 (wt %) |
|---|---|---|---|
| Base A | 100 | — | — |
| Base B | — | 100 | 99.925 |
| Sclareolide (1) | — | — | 0.075 |

(1) Food grade sclareolide, ex Avoca, USA

The samples were then evaluated by a trained panel of 10 people. Tasting was performed by a blind and balanced presentation order of the samples with the intensity of acidity, bitterness, sweetness and liquorice all being assessed on a scale of 0 to 5 where 0 represents not perceptible and 5 represents very intense.

The scores were averaged and an analysis of variance was performed to identify significant differences between the samples. The results are given in the following table.

TABLE 3

| Attribute | Sample 1 | Sample 2 | Sample 3 |
|---|---|---|---|
| Acidity (1) | 1.73 | 1.68 | 1.68 |
| Bitterness (1) | 1.27 | 1.68 | 1.45 |
| Sweetness (1) | 2.59 | 3.32 | 3.05 |
| Liquorice (2) | 0.73 | 2.41 | 1.50 |

(1) No significant difference between the samples
(2) Significant difference between the samples

The results demonstrate that the addition of the stevia derivative increases the liquorice taste of the product. Moreover, the results then show that the use of sclareolide significantly reduces the liquorice taste. Surprisingly, the sclareolide does not appear to have a significant effect on the acidity, bitterness or sweetness of the product.

### Example 3

### Evaluation of a Carbonated Cola Beverage Formulation

A cola beverage syrup base was prepared by mixing together the following ingredients:

TABLE 4

| Ingredient | Amount |
|---|---|
| Natural Cola Emulsion (Firmenich ref. 599077T) | 7.20 g |
| Caramel Color (20% solution) | 26.0 g |
| Phosphoric acid (85% solution) | 2.80 ml |
| Citric acid (anhydrous) | 0.40 g |
| Tartaric acid | 0.50 g |
| Sodium Benzoate (18% w/w solution) | 10 ml |
| Caffeine | 0.60 g |
| Stevia (see footnote 3 table 1) | 2.40 g |
| Water | To 1 litre |

To a 1 litre portion of the syrup base was added 6 g of sclareolide, ex Avoca (1% w/v ethanolic solution). The mixture was then dilute with 5 litres of carbonated water to provide sclareolide at 10 ppm. This is referred to as sample 4.

Another 1 litre portion of the syrup base was used as is (i.e. with no sclareolide present) and was diluted with 5 litres of carbonated water. This is referred to as sample 5.

31 panellists were then asked to evaluate samples 4 and 5 in a balanced, randomized blind test for Overall Flavor, Sweetness, Tartness/Acidity, Lingering Aftertaste, Metallic/Bitterness, Off-note aftertaste and Liquorice Flavor on an 11-point continuous intensity scale where 0=Imperceptible and 10=Extremely Pronounced. The results are given in the following table:

TABLE 5

| Attribute (intensity) | Sample 4 | Sample 5 | P-Value |
|---|---|---|---|
| Overall Flavor | 6.31 | 6.15 | 0.591 |
| Sweetness | 4.62 | 5.56 | 0.006 |
| Tartness/Acidity | 5.23 | 4.08 | 0.004 |
| Lingering Aftertaste | 5.89 | 4.54 | 0.004 |
| Metallic Bitterness | 5.44 | 3.47 | 0.000 |
| Off-note Aftertaste | 5.04 | 3.37 | 0.001 |
| Liquorice | 3.20 | 2.78 | 0.383 |

The results demonstrate that:
(i) there was no significant difference in overall flavor intensity or licorice flavor intensity between the two samples (at 90% confidence);
(ii) sample 5 had significantly more sweetness intensity than sample 4;
(iii) sample 4 had significantly more tartness, lingering aftertaste, metallic/bitterness and off-note intensity than sample 5 (at 90% confidence).

### Example 4

### Evaluation of a Carbonated Lemon Beverage Formulation

A lemon beverage syrup base was prepared by mixing together the following ingredients:

TABLE 6

| Ingredient | Amount |
|---|---|
| Citric acid (anhydrous) | 2.88 g |
| Tartaric acid | 3.60 g |
| Sodium Benzoate (18% w/v solution) | 10 ml |
| Sodium citrate | 0.60 g |
| Natural Lemon WONF (Firmenich ref 540374 CW) | 6 ml |
| Stevia (see footnote 3 table 1) | 2.40 g |
| Water | To 1 litre |

To a 1 litre portion of the syrup base was added 6 g of sclareolide, ex Avoca (1% w/v ethanolic solution). The mixture was then dilute with 5 litres of carbonated water to provide sclareolide at 10 ppm. This is referred to as sample 6.

To another 1 litre portion of the syrup base was added 0.12 g of sclareolide, ex Avoca (1% w/v ethanolic solution). The mixture was then dilute with 5 litres of carbonated water to provide sclareolide at 0.2 ppm. This is referred to as sample 7.

A third portion of the syrup base was used as is (i.e. with no sclareolide present) and was diluted with 5 litres of carbonated water. This is referred to as sample 8.

30 panellists were then asked to evaluate (i) sample 6 and sample 8 and (ii) sample 7 and sample 8 in a balanced, randomized blind test for Overall Flavor, Sweetness, Tartness/Acidity, Lingering Aftertaste, Metallic/Bitterness, Off-note aftertaste and Liquorice Flavor on an 11-point continuous intensity scale where 0=Imperceptible and 10=Extremely Pronounced. The results are given in the following tables:

TABLE 7

| Attribute (intensity) | Sample 6 | Sample 8 | P-Value |
|---|---|---|---|
| Overall Flavor | 6.12 | 6.15 | 0.909 |
| Sweetness | 4.77 | 5.35 | 0.115 |
| Tartness/Acidity | 4.57 | 4.26 | 0.424 |
| Lingering Aftertaste | 5.45 | 4.95 | 0.239 |
| Metallic Bitterness | 4.70 | 3.87 | 0.041 |
| Off-note Aftertaste | 4.64 | 3.51 | 0.011 |
| Liquorice | 3.32 | 2.64 | 0.032 |

TABLE 8

| Attribute (intensity) | Sample 7 | Sample 8 | P-Value |
|---|---|---|---|
| Overall Flavor | 6.00 | 6.10 | 0.724 |
| Sweetness | 5.38 | 5.42 | 0.904 |
| Tartness/Acidity | 4.92 | 4.71 | 0.494 |
| Lingering Aftertaste | 4.85 | 4.68 | 0.562 |
| Metallic Bitterness | 3.51 | 3.47 | 0.903 |
| Off-note Aftertaste | 3.40 | 3.24 | 0.521 |
| Liquorice | 3.05 | 2.92 | 0.659 |

The results in table 7 show that:
(i) there was no significant difference in overall flavor intensity, sweetness intensity, tartness intensity or lingering aftertaste intensity between the two samples (at 90% confidence);
(ii) sample 6 had significantly more metallic/bitterness, off-note intensity and liquorice flavor intensity than sample 8 (at 90% confidence).

Thus, at 10 ppm of sclareolide, the achievement of masking liquorice notes is not achieved.

The results in table 8 demonstrate that there was no significant difference in any of the measured attributes between the two samples (at 90% confidence) indicating that at 0.2 ppm of sclareolide, there is little or no masking effect observed.

1. to 7. (canceled)

8. A sweetening composition comprising:
a stevia compound, and
a compound according to formula (I) 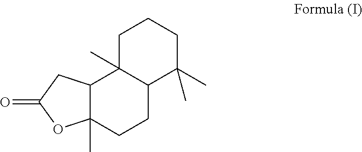 [SMILES: CC1(C)CCCC2(C)C1CCC1(C)OC(=O)CC12]
wherein the compound according to formula (I) is present in an amount of at least 0.0001%, by weight based on the total weight of the sweetening composition.

9. The sweetening composition of claim 8, wherein the stevia compound is a stevia extract comprising at least 95% by weight of rebaudioside A.

10. The sweetening composition of claim 8, wherein the stevia compound is present in an amount of 5 to 300 ppm and the compound of Formula I is present in an amount of 0.01 to 20 ppm.

11. The sweetening composition of claim 8, wherein the stevia compound is present in an amount of 25 to 200 ppm and the compound of Formula I is present in an amount of 0.5 to 10 ppm.

12. The sweetening composition of claim 8, wherein the stevia compound is present in an amount of 50 to 100 ppm and the compound of Formula I is present in an amount of 0.7 to 5 ppm.

13. The sweetening composition of claim 8, wherein the stevia compound is stevia or a derivative thereof.

14. A foodstuff or base that includes the sweetening composition according to claim 8.

15. The foodstuff or base of claim 14, wherein the compound of Formula I is present in an amount of 0.025 to 9 ppm.

16. A method of reducing or masking the liquorice note of a stevia compound which comprises applying a compound according to formula (I) 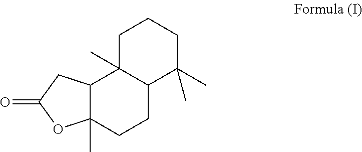 [SMILES: CC1(C)CCCC2(C)C1CCC1(C)OC(=O)CC12]
into a composition comprising the stevia compound, wherein the compound according to formula (I) is present in an amount of at least 0.0001%, by weight based on the total weight of the sweetening composition.
